(19) United States
(12) Patent Application Publication
(10) Pub. No.: US 2007/0103366 A1
(43) Pub. Date: May 10, 2007

(54) Antenna system for tracking moving object mounted satellite and its operating method

(76) Inventor: Chan Goo Park, Daejeon (KR)

Correspondence Address: WILLIAM COLLARD;COLLARD & ROE, P.C., 1077 NORTHERN BOULEVARD, ROSLYN, NY, 11576, US

(21) Appl. No.: 10/580,892

(22) PCT Filed: Mar. 17, 2004
(86) PCT No.: PCT/KR04/00583

§ 371 Date: May 26, 2006

(30) Foreign Application Priority Data
Nov. 27, 2003 (KR) 10-2003-0085296
Jan. 19, 2004 (KR) 10-2004-0003631

(51) Int. Cl. H01Q 3/00

(52) U.S. Cl. 342/359; 343/757; 343/760

(57) ABSTRACT

An improved satellite tracking antenna system mounted to a moving object and a method for operating the same detect and track elevation and azimuth angles of a satellite using only two gyro sensors in a two-axis satellite tracking antenna system, and detect and track an azimuth angle of the satellite using only one gyro sensor in a one-axis satellite tracking antenna system. The antenna system detects the satellite position using two gyro sensors, which are mounted to be orthogonal to each other to a planar axis perpendicular to a satellite-directed target point of the antenna, and continuously tracks the satellite position using a calibration algorithm without using additional absolute angle sensors, resulting in simplified system configuration and reduced production costs.

### TECHNICAL FIELD

The present invention relates to an antenna system for tracking a satellite and a method for operating the same, and more particularly to an improved satellite tracking antenna system mounted to a moving object and a method for operating the same, which detect and track elevation and azimuth angles of the satellite using only two gyro sensors in a two-axis satellite tracking antenna system, and detect and track an azimuth angle of the satellite using only one gyro sensor in a one-axis satellite tracking antenna system.

### BACKGROUND ART

Typically, an antenna system for tracking a satellite (hereinafter referred to as a satellite tracking antenna system) is classified into a one-axis antenna system, a two-axis antenna system, and a three-axis antenna system according to the number of motors capable of controlling an antenna direction to track the satellite.

The one-axis antenna system fixes an elevation angle of an antenna, and controls only an azimuth angle of the antenna using only one motor, such that it tracks a satellite position. The two-axis antenna system uses first and second motors, controls an elevation angle of an antenna using the first motor, and controls an azimuth angle of the antenna using the second motor, such that it tracks a satellite position. The three-axis antenna system further includes a horizontal-axis control motor for controlling polarization in addition to the first and second motors contained in the above two-axis antenna system, and controls an elevation angle, an azimuth angle, and a horizontal angle of an antenna using three motors, such that it tracks a satellite position.

A moving object (e.g., a vehicle or a ship) to which any antenna system is mounted moves at three angles, i.e., a yaw angle, a pitch angle, and a roll angle. The two-axis antenna system for detecting the movement of such a moving object to track a satellite position installs a gyro sensor (i.e., an angular velocity sensor) in three directions (i.e., a yaw direction, a pitch direction, and a roll direction), and tracks a satellite position in response to the movement of the moving object, such that it can control elevation and azimuth angles of the antenna.

FIG. 1 is an installation conceptual diagram illustrating gyro sensors contained in a conventional two-axis antenna system. FIG. 2 is a structural diagram illustrating the conventional two-axis antenna system including the gyro sensors.

Referring to FIGS. 1˜2, gyro sensors R2 and R3 are arranged in parallel to a base plate 1 to detect the movement of pitch and roll directions of a moving object. The other gyro sensor R1 is arranged perpendicularly to the base plate 1 to detect the movement of a yaw direction (i.e., a heading direction). If an X-axis at which the gyro sensor R3 is installed is equal to a satellite direction (i.e., a target point) indicative of a target of an antenna, output signals of the gyro sensors R1 and R3 are associated with only an azimuth angle error from among all tracking errors of the antenna, such that they affect only an operation for controlling an azimuth angle direction of the antenna. The output signal of the gyro sensor R2 is associated with only an elevation angle error, such that it affects an operation for controlling an elevation angle of the antenna.

In the meantime, the above-mentioned gyro sensors generate unexpected errors according to peripheral environments, and the generated errors are accumulated. Two tilt sensors and a single magnetic sensor, which are indicative of absolute angle sensors, are additionally required to calibrate the above-mentioned accumulated errors. The two tilt sensors from among the absolute angle sensors to calibrate the accumulated errors are adapted to detect individual slopes of horizontal directions (i.e., an X-axis and a Y-axis). The magnetic sensor from among the absolute angle sensors is adapted to detect the slope of a vertical direction (i.e., Y-axis direction). The satellite position can be tracked using output signals of the above-mentioned gyro sensors, other output signals of the above-mentioned absolute angle sensors, and the intensity of a satellite signal received from a satellite.

The above-mentioned conventional two-axis antenna system must use three gyro sensors, two tilt sensors, and the single magnetic sensor to track the satellite signal, such that it unavoidably increases complexity in system configuration. Also, the conventional two-axis antenna system must analyze individual output signals of a plurality of sensors to track the satellite position, such that it incurs a complicated procedure for tracking the satellite position, has difficulty in implementing the antenna, and increases the total production costs.

In the meantime, the conventional one-axis antenna system is designed to control only the azimuth angle without considering an elevation angle, resulting in a simplified system configuration. FIG. 3 is a structural diagram illustrating the conventional one-axis antenna system including a gyro sensor.

As shown in FIG. 3, the conventional one-axis antenna system includes a single gyro sensor R in a yaw direction perpendicular to an antenna base plate 1, such that it can detect the movement of an azimuth angle of a moving object to which the antenna system is mounted. However, the one-axis antenna system does not sufficiently consider a horizontal slope of the moving object, such that it is unable to detect an accurate azimuth angle of the moving object. In order to correctly detect the movement of the moving object, the one-axis antenna system must simultaneously detect the movements of yaw and roll directions of the moving object to calculate the azimuth angle. In this case, the one-axis antenna system requires two gyro sensors, resulting in increased production costs. Indeed, in order to prevent such production costs from being increased, the conventional one-axis antenna system has been designed to detect only the movement of yaw direction to control the azimuth angle.

[DISCLOSURE]

[TECHNICAL PROBLEM]

Therefore, the present invention has been made in view of the above problems, and, it is an object of the present invention to provide an improved satellite tracking antenna system mounted to a moving object and a method for operating the same, which detect a satellite position using only two gyro sensors in a two-axis antenna system, and continuously track the satellite position using a calibration algorithm without using additional absolute angle sensors.

It is another object of the present invention to provide an improved satellite tracking antenna system mounted to a moving object, which correctly detects and tracks an azimuth angle of a satellite using only one gyro sensor in a one-axis antenna system.

[TECHNICAL SOLUTION]

In accordance with one aspect of the present invention, the above and other objects can be accomplished by the provision of a satellite tracking antenna system mounted to a moving object to track a satellite position, which includes an antenna unit for receiving a satellite signal; a gyro sensor unit for detecting the movement of a moving object; a control board for receiving intensity information of the satellite signal from the antenna unit, receiving moving information of the moving object from the gyro sensor unit, and tracking the satellite position according to the received intensity and moving information; and an azimuth angle motor and an elevation angle motor for rotating the antenna unit to be directed to the satellite according to a control signal generated from the control board, the system comprising: the gyro sensor unit including first and second gyro sensors which are mounted to be orthogonal to each other to a planar axis perpendicular to a satellite-directed target point of the antenna unit, wherein the first gyro sensor is mounted in parallel to the planar axis to measure a first angular velocity variable in an elevation angle of the moving object, such that it transmits the first angular velocity variable in the elevation angle to the control board, and the second gyro sensor is mounted in perpendicular to the planar axis to measure a second angular velocity variable in an azimuth angle of the moving object, such that it transmits the second angular velocity variable in the azimuth angle to the control board.

Preferably, the first and second gyro sensors contained in the gyro sensor unit are arranged to be orthogonal to each other to a back surface of an antenna plate for supporting an antenna contained in the antenna unit, in which the first gyro sensor is arranged in a horizontal direction and the second gyro sensor is arranged in a vertical direction.

Preferably, the azimuth angle motor is mounted onto a fixed base plate capable of being horizontally rotated by a vertical axis in an antenna lower cover detachably covered with a dome-shaped cover, mounts a bearing for use in the vertical axis onto a top surface of the base plate, and transmits power to the vertical axis exposed toward a lower part of the base plate via a timing belt connected to a lower drive pulley.

Preferably, the elevation angle motor is mounted to a motor fixing unit, which is bent and formed on one surface of a fixed base plate capable of being horizontally rotated by a vertical axis via a bearing in an antenna lower cover detachably covered with a dome-shaped cover.

Preferably, a semicircular pulley is fixed by first and second fixed plates to one side of a back surface of an antenna plate for supporting the antenna contained in the antenna unit, and a third fixed plate is fixed to the other side of the back surface of the antenna plate, such that the first to third fixed plates are rotatably coupled to an extended-bent support unit located on both sides of the base plate, and are rotated on the basis of a horizontal axis, and a timing belt fixes its one end to both ends of the semicircular pulley, and is connected to a drive pulley of, the elevation angle motor via a separation prevention groove formed on a circumference of the semicircular pulley, such that the elevation angle of the antenna plate is controlled.

In accordance with another aspect of the present invention, there is provided a satellite tracking method for use in a satellite tracking antenna system mounted to a moving object to track a satellite position, which includes an antenna unit for receiving a satellite signal; a gyro sensor unit for detecting the movement of a moving object; a control board for receiving intensity information of the satellite signal from the antenna unit, receiving moving information of the moving object from the gyro sensor unit, and tracking the satellite position according to the received intensity and moving information; and an azimuth angle motor and an elevation angle motor for rotating the antenna unit to be directed to the satellite according to a control signal generated from the control board, the method comprising the steps of: a) measuring reference output values of first and second gyro sensors contained in the gyro sensor unit, the first and second gyro sensors being mounted to a back surface of an antenna plate perpendicular to a satellite-directed target point of the antenna unit such that they are orthogonal to each other in horizontal and vertical directions; b) horizontally and vertically rotating the antenna unit using the azimuth angle motor and the elevation angle motor, detecting a specific point at which the intensity of the satellite signal received from the antenna unit is higher than a reference value, and detecting an initial position of the satellite on the basis of the detected point; c) receiving intensity information of the satellite signal from the antenna unit, receiving movement information in azimuth and elevation angles of the moving object from the first and second gyro sensors, and continuously tracking the satellite position detected at step (b) according to the received intensity and movement information; and d) calculating output values of the first and second gyro sensors continuously changed with peripheral environments at step (c) for tracking the satellite position, and calibrating reference output values of the first and second gyro sensors.

[ADVANTAGEOUS EFFECTS]

A satellite tracking antenna system and a method for operating the same according to the present invention detect a satellite position using only two gyro sensors in a two-axis antenna system, and continuously track the satellite position using a calibration algorithm without using additional absolute angle sensors, such that it can be manufactured in the form of a simplified configuration, resulting in reduced production costs.

Also, the satellite tracking antenna system according to the present invention correctly detects and tracks an azimuth angle of a satellite using only one gyro sensor in a one-axis antenna system.

### BRIEF DESCRIPTION OF DRAWINGS

The above and other objects, features and other advantages of the present invention will be more clearly understood from the following detailed description taken in conjunction with the accompanying drawings, in which:

FIG. 1 is an installation conceptual diagram illustrating gyro sensors contained in a conventional two-axis antenna system;

FIG. 2 is a structural diagram illustrating the conventional two-axis antenna system including the gyro sensors;

FIG. 3 is a structural diagram illustrating the conventional one-axis antenna system including a gyro sensor;

FIG. 4 is an installation conceptual diagram illustrating gyro sensors contained in a two-axis antenna system in accordance with the present invention;

FIG. 5 is a structural diagram illustrating the two-axis antenna system in accordance with a preferred embodiment of the present invention;

FIG. 6 is an exploded perspective view illustrating a satellite tracking antenna system in accordance with a preferred embodiment of the present invention;

FIGS. 7, 8, and 9 show a coupling state of a satellite tracking antenna system in accordance with a preferred embodiment of the present invention;

FIG. 10 is a rear view illustrating an antenna plate of the satellite tracking antenna system in accordance with a preferred embodiment of the present invention;

FIG. 11 is a block diagram illustrating a satellite tracking antenna system in accordance with a preferred embodiment of the present invention;

FIG. 12 is a flow chart illustrating a calibration process of a gyro sensor unit when initially tracking a satellite in accordance with a preferred embodiment of the present invention;

FIG. 13 is a flow chart illustrating a process for calibrating an error generated in a gyro sensor unit when tracking a satellite position in accordance with a preferred embodiment of the present invention;

FIG. 14 is a conceptual diagram illustrating an exemplary moving direction of an antenna unit during the process for calibrating the error of the gyro sensor unit in FIG. 13 in accordance with a preferred embodiment of the present invention;

FIG. 15 is a rear view illustrating an antenna plate of a one-axis satellite tracking antenna system in accordance with another preferred embodiment of the present invention;

FIG. 16 is a structural diagram illustrating a one-axis satellite tracking antenna system in accordance with yet another preferred embodiment of the present invention; and

FIG. 17 shows an example in which an antenna system for tracking a satellite is applied to a parabolic antenna in accordance with the present invention.

### BEST MODE FOR CARRYING OUT THE INVENTION

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the,subject matter of the present invention rather unclear.

FIG. 4 is an installation conceptual diagram illustrating a satellite tracking antenna system including two gyro sensors to track a satellite position in accordance with the present invention. Prior to describing FIG. 4, a plurality of symbols shown in FIG. 4 will hereinafter be described:

X-axis: Center axis for detecting an angular velocity variable in a roll direction;

Y-axis: Center axis for detecting an angular velocity variable in a pitch direction;

Z-axis: Center axis for detecting an angular velocity variable in a yaw direction;

X′-axis: Center axis of a satellite target point indicative of an object direction of an antenna;

Z′-axis: Z-axis conversion axis generated when converting the X-axis into the X′-axis on the basis of the Y-axis;

α: X-axis and X′-axis angles

Φ: Angle for controlling an antenna rotation azimuth of an azimuth angle motor;

Φ′: Angular velocity output value of a gyro sensor R1′ contained in the Z′ -axis; and

θ: Angle for controlling an antenna rotation elevation angle of an elevation angle motor (=Angular velocity output value of a gyro sensor R2 contained in the Y-axis).

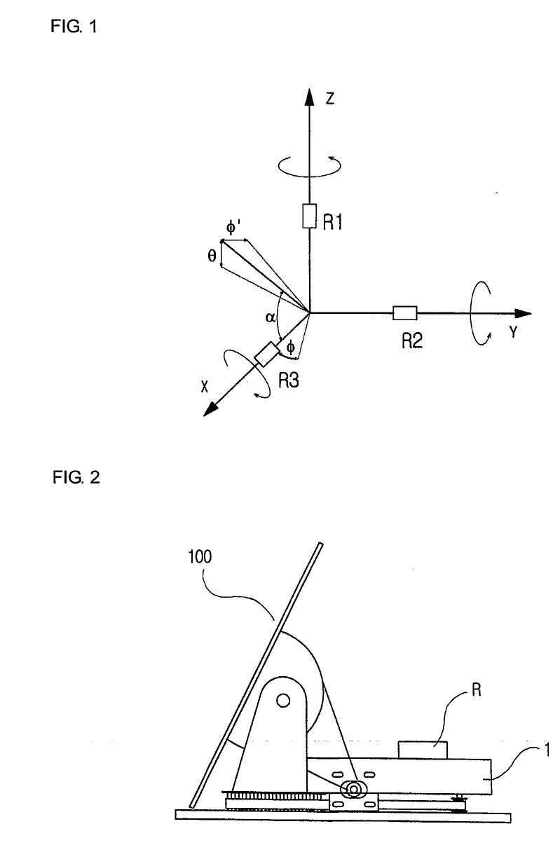

Referring to FIG. 4, the satellite tracking antenna system according to the present invention includes first and second gyro sensors for detecting the movement of a moving object in order to track a satellite position. The first gyro sensor is arranged in the same direction as the gyro sensor R2 shown in FIG. 1. In more detail, the first gyro sensor is arranged on the Y-axis to detect a variation in elevation angle of a moving object.

The second gyro sensor is arranged on the Z′-axis to detect a variation in azimuth angle of the moving object. The Z′-axis is created by conversion of the Z-axis shown in FIG. 1. In the case of rotating the X-axis of FIG. 1 by a predetermined angle of α on the basis of the Y-axis in order to allow the X-axis to coincide with the X′-axis indicative of a satellite-directed target point direction having a predetermined angle of α on the basis of the X-axis, an axis conversion operation occurs, such that the Z-axis perpendicular to the X-axis is also converted into the Z′-axis perpendicular to the X′-axis. In more detail, the Z′-axis is perpendicular to a satellite-directed target point X′-axis.

In this case, the gyro sensor R1 arranged on the Z-axis in FIG. 1 is converted into the other gyro sensor R1′ arranged on the Z′-axis in FIG. 2 due to the axis conversion operation of the Z-axis. The output value Φ′ of the gyro sensor R1′ affects an azimuth control angle Φ for controlling an azimuth angle using an azimuth angle motor. The output value η of the gyro sensor R2 arranged on the Y-axis, axis conversion of which is not performed, coincides with an elevation control angle θ for controlling an elevation angle using an elevation angle motor in the same manner as in FIG. 1.

If the axis conversion is performed by the above-mentioned operations, the gyro sensor R3 arranged on the X-axis is located on the X′-axis of FIG. 2, such that the output signal of the gyro sensor R3 capable of detecting a rotation speed of the X′-axis is not affected by a variation in satellite position. As a result, the output signal of the gyro sensor R3 becomes meaningless, such that it is not used to track the satellite. Therefore, differently from the conventional method of FIG. 1, which acquires sensor output values using the gyro sensors R1 and R3 and the absolute sensors (i.e., two tilt sensors and a single magnetic sensor), calculates the acquired sensor output values using a complicated axis-conversion equation, calculates an error angle of the azimuth control angle Φ according to the calculated result, and e calculates an error-corrected azimuth control value Φ, the present invention substitutes the gyro sensors R1 and R3 into a single gyro sensor R1′, and calculates an error angle of the azimuth control angle Φ on the basis of the angle Φ′ without using the above absolute angle sensors, such that it controls an azimuth angle according to the calculated result.

The output value Φ′ of the gyro sensor R1′ and the azimuth control value Φ have different correlation coefficients according to an elevation angle of a satellite, such that a control constant must be controlled according to used areas of an elevation angle when constructing a control board. Also, the present invention controls elevation and azimuth angles of an antenna using only a gyro sensor acting as a relative angle sensor without using an absolute angle sensor, such that it requires a calibration algorithm capable of reducing an accumulated error of a gyro sensor. The calibration algorithm will hereinafter be described.

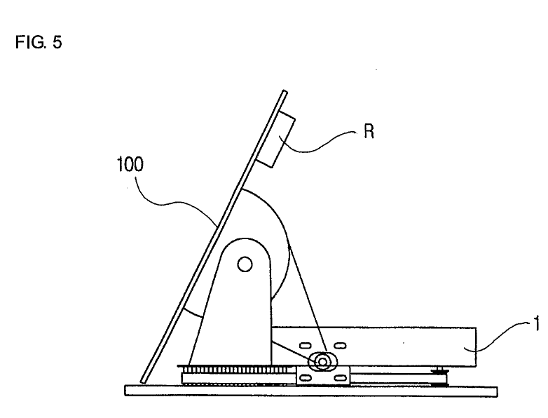

FIG. 5 is a structural diagram illustrating a satellite tracking antenna system in accordance with a preferred embodiment of the present invention. Differently from the conventional antenna system of Fig, 2, which horizontally mounts three gyro sensors R onto an antenna base plate 1, calculates output signals of the gyro sensors R1 and R3 associated with yaw and roll angles, and controls an azimuth angle motor according to the calculated result, an antenna system according to the present invention mounts a gyro sensor R to a back surface of an antenna unit 100 in a predetermined direction perpendicular to an target direction of the antenna unit 100, such that it can control an azimuth angle motor using output signals of the gyro sensors without performing additional calculations.

A preferred embodiment of a satellite tracking antenna system to which a satellite tracking concept using the above-mentioned two gyro sensors is applied will hereinafter be described.

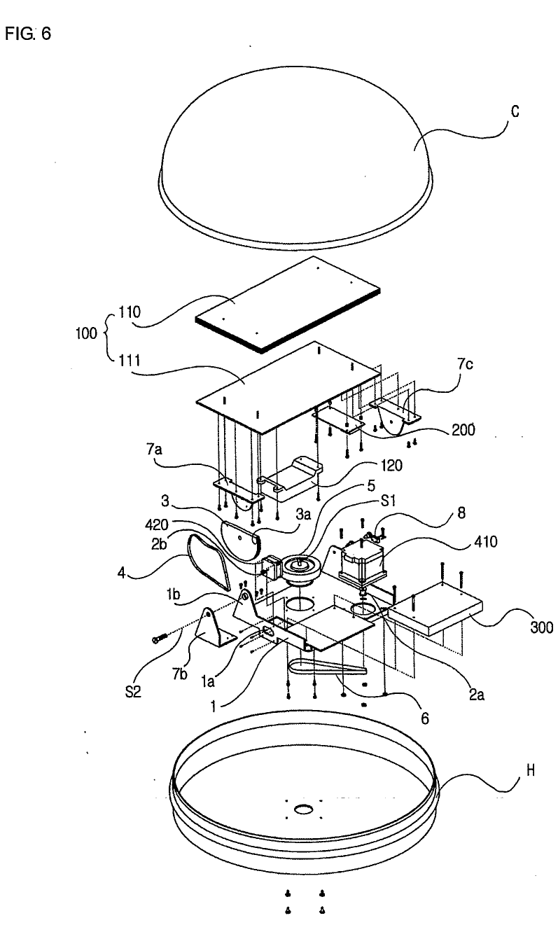

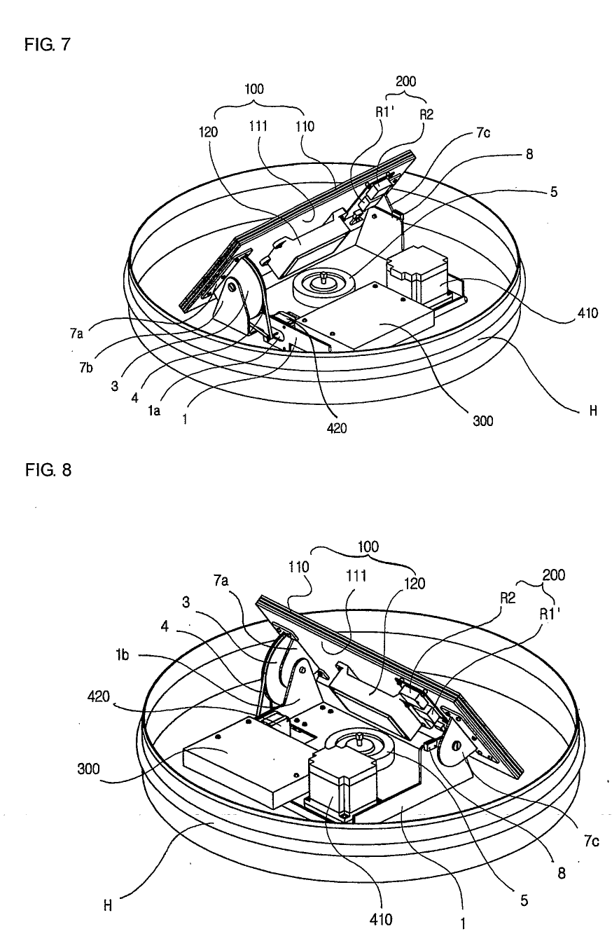

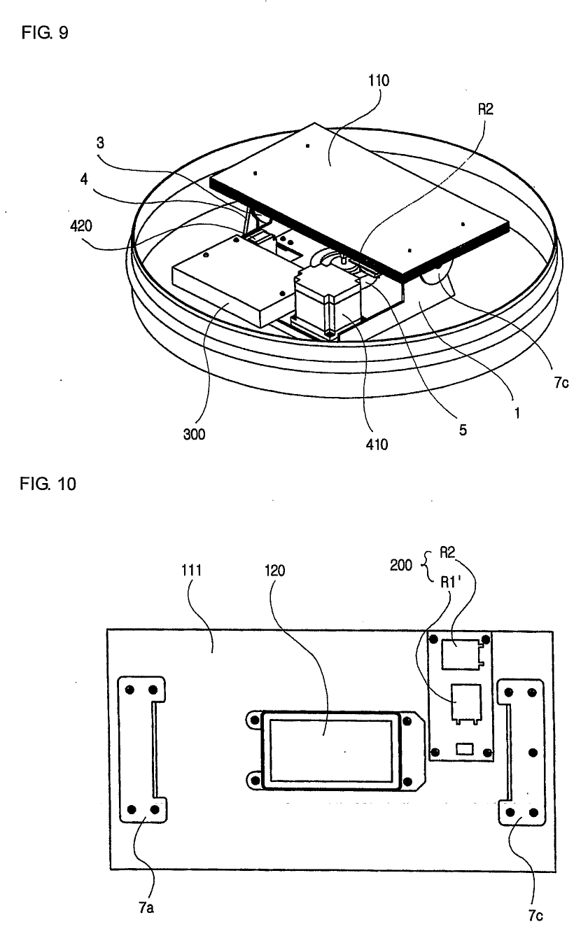

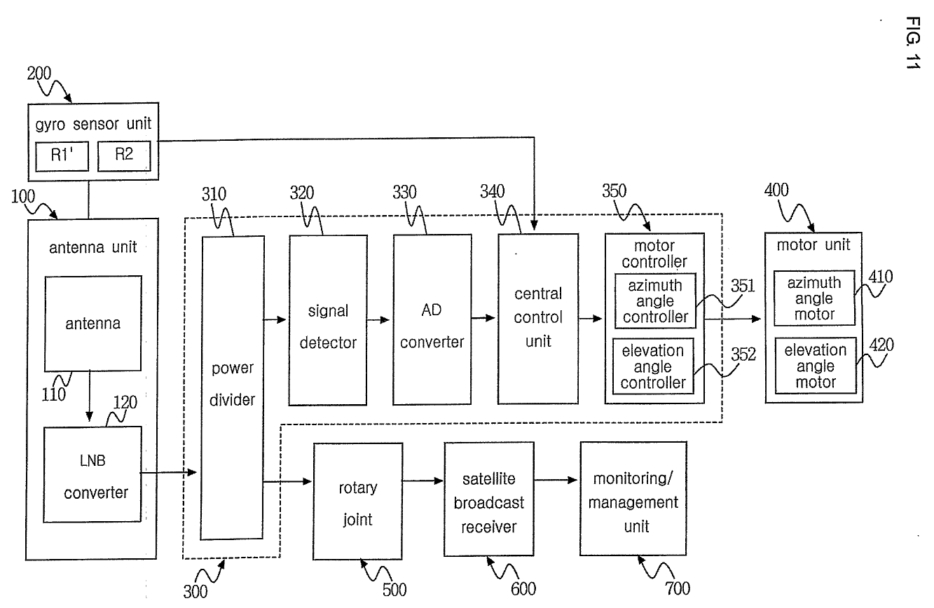

FIG. 6 is an exploded perspective view illustrating a two-axis satellite tracking antenna system in accordance with a preferred embodiment of the present invention. FIGS. 7, 8, and 9 show a coupling state of the two-axis satellite tracking antenna system in accordance with a preferred embodiment of the present invention. FIG. 10 is a rear view illustrating an antenna plate of the two-axis satellite tracking antenna system in accordance with a preferred embodiment of the present invention.

Referring to FIGS. 6˜9, the satellite tracking antenna system mounts an azimuth angle motor 410 for controlling an azimuth angle of an antenna 110 and an elevation angle motor 420 for controlling an elevation angle of the antenna 110 onto a fixed base plate 1 capable of being horizontally rotated by a vertical axis S1 in an antenna lower cover H detachably covered with a dome-shaped cover C. The above-mentioned two motors 410 and 420 are controlled by a control signal of a control board 300 to track a satellite position, such that the motor 410 controls the azimuth angle of the antenna 110 and the other motor 420 controls the elevation angle of the antenna 110.

Referring to FIG. 10, two gyro sensors R1′ and R2 according to the present invention are arranged to be orthogonal to each other on a back surface of an antenna plate 111 to which the antenna 110 instead of a base plate 1 is fixed. The first gyro sensor R1′ is arranged to be perpendicular to a target direction of the antenna 110, such that it reacts to an azimuth angle changed by variations in yaw and roll angles. The second gyro sensor R2 is arranged to be perpendicular to the above-mentioned first gyro sensor R1′. In other words, the second gyro sensor R2 is horizontally attached to the back surface of the antenna plate 111, such that it reacts to the elevation angle of the antenna 110.

The mechanical mechanism for controlling the azimuth angle of the antenna 110 is equal to that of a conventional satellite tracking antenna, such that its detailed description will herein be omitted for the convenience of description. However, a bearing 5 for use in the vertical axis S1 is mounted to the top surface of the base plate 1, such that an axis length including a drive pulley 2a of the azimuth angle motor 410 which transmits power to the vertical axis S1 exposed toward a lower part of the base plate 1 via a timing belt 6 can be shortened, resulting in minimized eccentric load applied to a shaft of the azimuth angle motor 410.

It can be recognized that the present invention further simplifies the mechanical mechanism for controlling the elevation angle of the antenna 110 as compared to conventional mechanical mechanisms, such that individual components can be conveniently fabricated and production costs can be reduced. The elevation angle motor 420 bends an one surface of the base plate 1, and directly forms the motor fixing unit la to the bent portion of the base plate 1, such that there is no need for a fixed bracket to be additionally manufactured, and the number of fabrications is reduced. Also, the elevation angle motor 420 prevents a bracket from being loosened by a repulsive force generated during a predetermined time during which the elevation angle motor 420 is driven, such that it reduces durability of the antenna and the possibility of antenna malfunction.

In order to control the elevation angle of the antenna 110, a semicircular pulley 3 is directly fixed to one side of the back surface of the antenna plate 111. Two fixed plates 7a and 7b are fixed to both sides of the pulley 3, and are arranged in parallel to each other. A fixed plate 7c having the same size as the fixed plate 7a is mounted to the other side of the back surface of the antenna plate 111, is rotatably fixed to an extended-bent support unit 1b located on both sides of the base plate 1, and is rotated on the basis of a horizontal axis S2. A timing belt 4 is connected between the semicircular pulley 3 and a drive pulley 2b of the elevation angle motor 420. Provided that the timing belt 4 is fixed to both ends of the semicircular pulley 3, and a groove 3a for preventing separation of the timing belt 4 is formed on the circumstance of the semicircular pulley 3, the present invention can accurately transmit drive force of the elevation angle motor 420 indicative of a step motor to the semicircular pulley 3 via the timing belt 4 without forming sawteeth (i.e., gear teeth) on the circumstance of the semicircular pulley 3, such that it can correctly control the elevation angle of the antenna, and the mechanical mechanism for controlling the elevation angle is simplified, resulting in reduced production costs.

In order to smoothly control the elevation angle of the antenna plate 111, the present invention inserts a bearing (not shown) in the semicircular pulley 3, such that the horizontal axis S2 can be smoothly rotated. The semicircular pulley 3 is fixed to the back surface of the antenna plate 111. In order to solve non-smooth rotation generated in an elevation angle direction due to the eccentricity of power generated by the elevation motor 420 and the timing belt 4, two fixed plates 7a and 7b parallel to each other are fixed to both sides of the semicircular pulley 3.

In the meantime, the present invention properly arranges the azimuth angle motor 410, the elevation angle motor 420, and the control board 300 on the base plate 1 in consideration of weight and position of the antenna plate 111, such that it prevents the eccentricity of a center of gravity of the base plate 1 in a rotation direction centering around the horizontal axis S1, resulting in minimized load generated during the drive time of the azimuth angle motor 410.

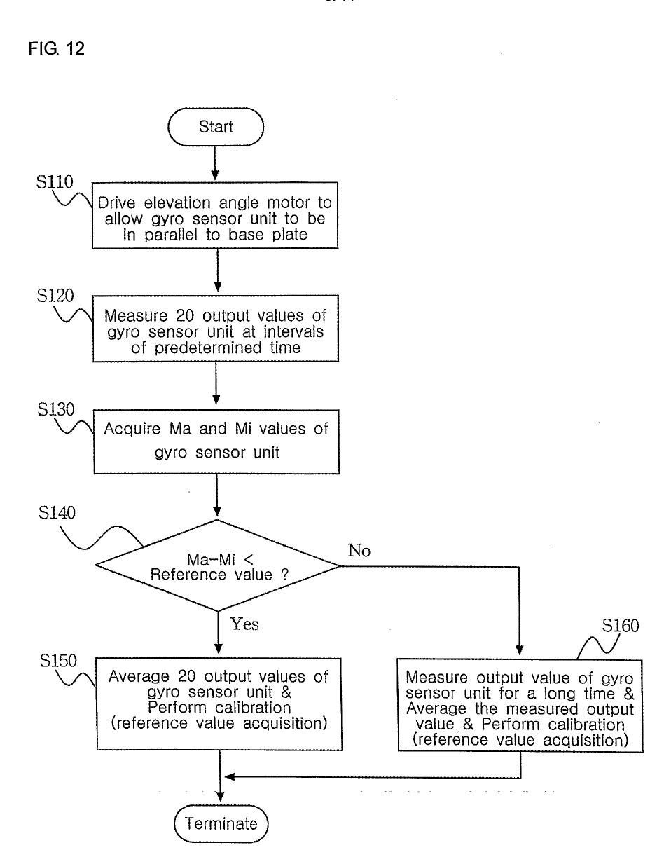

Reference number 8 is indicative of a limit switch. The limit switch 8 is turned on when the antenna plate 111 is arranged in parallel to the base plate 1 as shown in FIG. 9, and is used for a calibration process for establishing output reference values of the gyro sensors R1′ and R2 to initially track a satellite position. In more detail, if the limit switch 8 detects that the antenna plate 111 is arranged in parallel to the base plate 1, the gyro sensor unit 200 mounted to the back surface of the antenna plate 111 is arranged in parallel to the base plate 1, such that the output values of the gyro sensors R1′ and R2 are not affected by the movement of yaw direction, and are affected only by the movements of pitch and roll directions. Therefore, the output reference values of the gyro sensors R1′ and R2 can be calculated by individual mean values of the pitch and roll direction movements, and an associated detailed description will be given with reference to FIG. 12.

FIG. 11 is a block diagram illustrating an antenna system including two gyro sensors in accordance with a preferred embodiment of the present invention.

Referring to FIG. 11, the satellite tracking system according to the present invention includes an antenna unit 100, which includes an antenna 110 for receiving a satellite signal from a satellite, and a Low Noise Block (LNB) down converter 120 (hereinafter referred to as an LNB converter 120) for converting a received satellite signal into an intermediate frequency (IF) satellite signal; a gyro sensor unit 200 installed to the back surface of the antenna unit 100 to detect the movement of a moving object; a control board 300 for analyzing a satellite signal transmitted over the antenna unit 100 and an angular velocity signal transmitted from the gyro sensor unit 200 to recognize a satellite position; a motor unit 400 for rotating the antenna unit 100 according to a satellite position recognized by the control board 300; and a rotary joint 500 acting as a transmission unit for transmitting the satellite signal received from the antenna unit 100 to the satellite broadcast receiver 600.

The gyro sensor unit 200 includes the gyro sensors R1′ and R2 as shown in FIGS. 4, 5 and 10. The gyro sensors R1′ and R2 are arranged to be orthogonal to each other on the back surface of the antenna unit 100, and are arranged in perpendicular to a target point of the antenna unit 100. The gyro sensor unit 200 transmits angular velocity signals of azimuth and elevation angles to the control board 300 according to the movement of a moving object to which the antenna system is mounted.

The control board 300 includes a power divider 310 for dividing the IF satellite signal received from the antenna unit 100 into the same two IF satellite signals; a signal detector 320 for receiving the IF satellite signals from the power divider 310, and detecting a satellite signal of a set frequency; an AD (Analog-to-Digital) converter 3130 for converting the IF satellite signals received from the signal detector 320 into digital IF satellite signals; a central control unit 340 for receiving the satellite signals from the AD converter 330, receiving angular velocity signals of azimuth and elevation angles of a moving object from the gyro sensor unit 200, analyzing the received satellite signals and the received angular velocity signals, and recognizing a satellite position; and a motor controller 350 for driving a motor unit 400 to rotate the antenna unit 100 according to the satellite position recognized by the central control unit 340.

The motor unit 400 includes an azimuth angle motor 410 for driving the antenna unit 100 in an azimuth angle direction upon receiving a control signal from an azimuth angle controller 351 contained in the motor controller 350 of the control board 300, and an elevation angle motor 420 for driving the antenna unit 100 in an elevation angle direction upon receiving a control signal from the elevation angle controller 352.

The signal detector 320 outputs an Automatic Gain Control (AGC) signal of a set frequency from among satellite signals transmitted via the power divider 310. The AD converter 330 converts the AGC signal received from the signal detector 320 into a digital AGC signal, and transmits the digital AGC signal to the central control unit 340. The central control unit 340 receives the AGC signal of the satellite signal from the AD converter 330, receives angular velocity signals of elevation and azimuth angles of the moving object from the gyro sensor unit 200, analyzes the received AGC signal and the received angular velocity signals, and tracks a satellite position according to the analyzed result.

The rotary joint 500 transmits the IF satellite signal divided by the power divider 310 of the control board 300 to the satellite broadcast receiver 600. The satellite signal transmitted to the satellite broadcast receiver 600 is displayed on a monitor 700. The rotary joint 500 receives an electric power signal from an external part, and transmits the electric power signal to the above-mentioned components.

A method for controlling a target direction of the antenna unit 100 to be directed to the satellite by initially detecting a satellite position and continuously tracking the satellite position using the control board 300 will hereinafter be described.

FIG. 12 is a flow chart illustrating a calibration process for establishing an output reference value of the gyro sensor unit 200 without using tilt sensors indicative of absolute angle sensors when initially tracking a satellite position in accordance with a preferred embodiment of the present invention.

Referring to FIG. 12, if a power-supply signal is applied to the antenna system, the elevation angle motor 420 is driven such that the gyro sensor unit 200 mounted to the back surface of the antenna plate 111 is arranged in parallel to the base plate 1 at step S110. The parallel state of the antenna plate 111 including the gyro sensor unit 200 and the base plate 1 is detected by the limit switch 8 mounted to the support unit 1b of the base plate 1. If the parallel state of the antenna plate 111 and the base plate 1 is detected by the limit switch 8, the control board 300 measures output values of the gyro sensors R1′ and R2 at intervals of a predetermined time 20 times at step S 120. In this case, it should be noted that the predetermined time at which the output values of the gyro sensors R1′ and R2 are measured and the number of measurement times of the output values of the gyro sensors R1′ and R2 can be properly determined according to peripheral environments.

If the output value of the gyro sensor unit 200 is measured 20 times, a maximum output value Ma and a minimum output value Mi of the gyro sensor unit 200 are detected and acquired at step S130. In this case, the maximum and minimum output values Ma and Mi of the gyro sensor unit 200 are acquired by the gyro sensor R1′, and the maximum and minimum output values Ma and Mi of the gyro sensor unit 200 are acquired by the gyro sensor R2.

If the maximum output value Ma and the minimum output value Mi of the gyro sensor unit 200 are acquired, a difference between the maximum and minimum output values Ma and Mi is calculated, and it is determined whether the calculated difference is less than a reference value at step S140. In this case, the above-mentioned process for calculating the difference between the maximum and minimum output values Ma and Mi is performed by the gyro sensors R1′ and R2, respectively.

If the difference between the maximum and minimum output values Ma and Mi is less than the reference value at step S140, it is determined that the moving object is in a stationary state, such that 20 measured output values of the gyro sensor unit 200 are averaged to perform a calibration process, and reference output values of the gyro sensors R1′ and R2 can be acquired at step S150. The above-mentioned reference output values are indicative of gyro sensor output values when the moving object is in the stationary state.

If the difference between the maximum and minimum output values Ma and Mi is higher than the reference value at step S140, it is determined that the moving object currently moves, such that output values of the gyro sensor unit 200 are measured during a longer period, the measured output values are averaged to perform a calibration process, and reference output values of the gyro sensors R1′ and R2 are acquired at step S160.

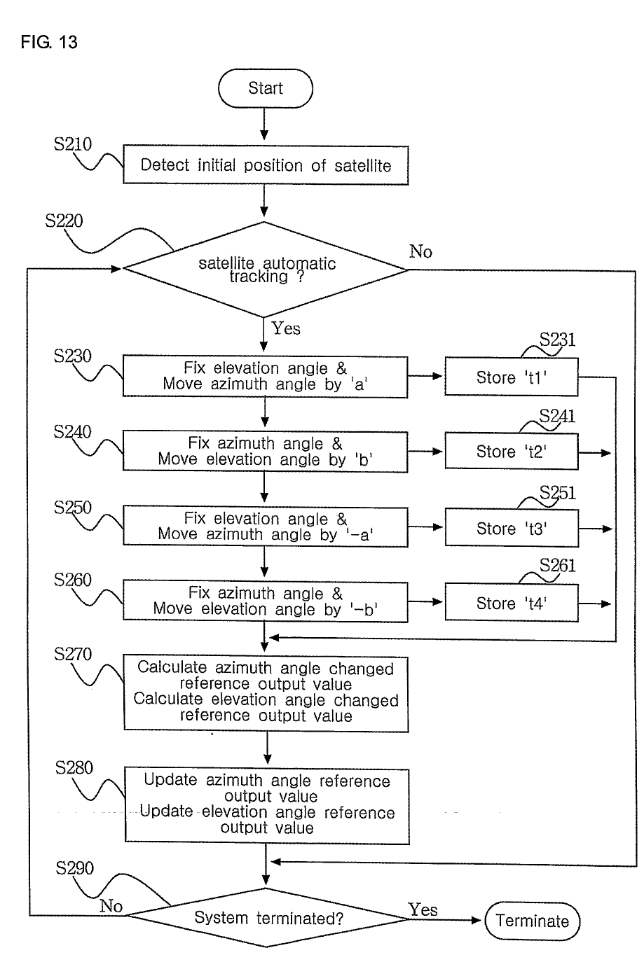

The reason why the gyro sensor unit 200 is arranged in parallel to the base plate 1 at step S110 is as follows. If the gyro sensor unit 200 is arranged in parallel to the base plate 1, the output value of the gyro sensor unit 200 is not affected by the movement of yaw direction, and is affected by only the movements of pitch and roll directions. Therefore, provided that a mean value of the pitch and roll direction movements is calculated, initial reference output values of the gyro sensors R1′ and R2 can be calculated without using absolute angle sensors such as additional tilt sensors, etc. The reference output values of the gyro sensors R1′ and R2 may vary with peripheral environments, such that they require a calibration process for continuously calibrating the reference output values of the gyro sensors R1′ and R2, and the calibration process will hereinafter be described with reference to FIG. 13.

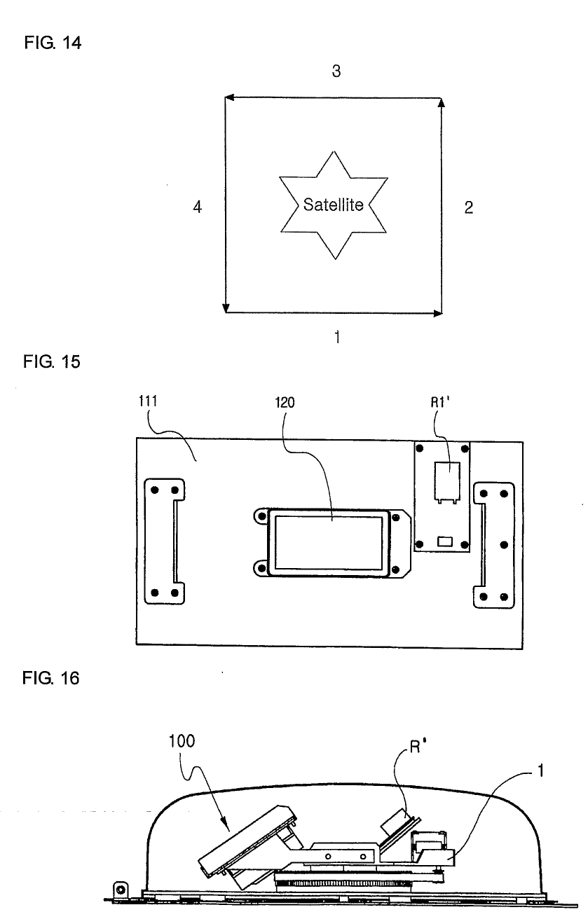

FIG. 13 is a flow chart illustrating a calibration process for calibrating an error generated in the gyro sensor unit when tracking a satellite position in accordance with a preferred embodiment of the present invention. FIG. 14 is a conceptual diagram illustrating an exemplary moving direction of the antenna unit during the calibration process of FIG. 13.

Referring to FIG. 13, if an initial position of a satellite is detected by a general satellite position detection method at step S210, the central control unit 340 continuously tracks a satellite position at step S220. The central control unit 340 receives the output values of two gyro sensors R1′ and R2 contained in the gyro sensor unit 200 to automatically track the satellite position, recognizes the movements of azimuth and elevation angles on the basis of the received output values, drives the azimuth angle motor 410 and the elevation angle motor 420 according to the recognized movements of the moving object, such that the antenna unit 100 can be continuously directed to the satellite. When tracking the satellite position according to the movement of the moving object using the gyro sensor R1′ for detecting the azimuth angle and the other gyro sensor R2 for detecting the elevation angle, reference output values of the gyro sensors R1′ and R2 may be changed with peripheral environments such as temperature and humidity, etc. If reference output value variations of the gyro sensors R1′ and R2 are accumulated, an unexpected error may occur in tracking the satellite position.

Referring to FIG. 14, in order to calibrate the reference output values of the above-mentioned gyro sensors, the control board 300 of the present invention drives the azimuth angle motor 410 after detecting the satellite position, and moves the antenna unit 100 to the right (i.e., the direction denoted by “1” in FIG. 14) by a predetermined angle ‘a’ at step S230. The azimuth angle motor 410 is driven by arbitrarily changing the reference output value of the gyro sensor R1′ to another value. In more detail, the reference output value of the gyro sensor R1′ is arbitrarily changed to another value, the control board 300 determines that the moving object is rotated in an azimuth angle direction by the changed output value of the gyro sensor R1′, and rotates the azimuth angle of the antenna unit 100 in the opposite direction in order to compensate for the above rotation in the azimuth angle direction of the moving object, such that the azimuth angle motor 410 is driven. If the azimuth angle of the antenna unit 100 moves by the predetermined angle ‘a’, an azimuth angle moving time ‘t1’ of the antenna unit 100 is stored in the control board 300 at step S231.

If the azimuth angle of the antenna unit 100 moves by the predetermined angle ‘a’, the control board 300 operates the elevation angle motor 420 under the condition that the azimuth angle motor 410 is in a stationary state, and moves the antenna unit 100 in an upward direction (i.e., the direction denoted by ‘1’) by a predetermined angle ‘b’ at step S240. In order to compensate for elevation angle movement of the moving object, corresponding to a changed output value generated when the reference output value of the gyro sensor R2 is arbitrarily changed to another value, the elevation angle motor 420 controls the elevation angle. If the elevation angle of the antenna unit 100 moves by the predetermined angle ‘b’ using the above-mentioned processes, an elevation angle moving time ‘t2’ of the antenna unit 100 is stored in the control board at step S241.

If the elevation angle of the antenna unit 100 moves by the predetermined angle ‘b’, the control board 300 drives the azimuth angle motor 410 under the condition that the elevation angle motor 420 is in a stationary state, and moves the antenna unit 100 by a predetermined angle ‘−a’ (i.e., the direction denoted by ‘3’) at step S250. If the azimuth angle of the antenna unit 100 moves by the predetermined angle ‘−a’, the azimuth angle of the antenna unit 100 compensates for the azimuth angle movement of the above step S230, such that it returns to the reference output value generated prior to its initial change operation. If the azimuth angle of the antenna unit 100 moves by the predetermined angle ‘−a’ using the above-mentioned processes, the azimuth angle moving time ‘t3’ of the antenna unit 100 is stored in the control board 300 at step S251.

If the azimuth angle of the antenna unit 100 moves by the predetermined angle ‘−a’, the control board 300 drives the elevation angle motor 420 under the condition that the azimuth angle motor 410 is in a stationary state, and moves the antenna unit 100 by a predetermined angle ‘−b’ (i.e., the direction denoted by ‘4’) at step S260. If the elevation angle of the antenna unit 100 moves by the predetermined angle ‘−b’, the elevation angle of the antenna unit 100 compensates for the elevation angle movement of the above step S240, such that it returns to the reference output value generated prior to its initial change operation. If the elevation angle of the antenna unit 100 moves by the predetermined angle ‘−b’ using the above-mentioned processes, the elevation angle moving time ‘t4’ of the antenna unit 100 is stored in the control board 300 at step S261.

The changed reference output value of the gyro sensor R1′ and the changed reference output value of the other gyro sensor R2 are calculated on the basis of data acquired from the above-mentioned processes. Individual changed reference output values of the gyro sensors R1′ and R2 can be acquired using the following equations at step S270.

$$\begin{matrix}R 1 ' s changed reference output value = R 1 ' s reference output value - \frac{( ( a \times t 1 ) - ( a \times t 3 ) )}{( t 1 + t 3 )} & [ Equation 1 ] \\ R 2 ' s changed reference output value = R 2 ' s reference output value - \frac{( ( b \times t 2 ) - ( b \times t 4 ) )}{( t 2 + t 4 )} & [ Equation 2 ]\end{matrix}$$

For example, in the first case where a reference output value ‘512’ of the gyro sensor R1′ is changed to another reference output value ‘502’ to rotate the azimuth angle of the antenna unit in the direction of ‘1’ in FIG. 14 such that the azimuth angle moves by a predetermined value ‘10’, and in the second case where the reference output value ‘512’ of the gyro sensor R1’ is changed to another reference output value ‘522’ to rotate the azimuth angle of the antenna unit in the direction of ‘3’ in FIG. 14 such that the azimuth angle moves by a predetermined value ‘−10’, if the reference output value of the gyro sensor R1’ is not changed to another value under the above-mentioned first and second cases, the moving time associated with the direction of ‘1’ must be equal to the other moving time associated with the direction of ‘3’. However, when measuring a real moving time, provided that a predetermined value ‘2’ is required when moving the reference output value of the gyro sensor R1′ in the direction of ‘1’ in FIG. 14, and a predetermined value ‘8’ is required when moving the reference output value of the gyro sensor R1′ in the direction of ‘3’ in FIG. 14, this indicates that the reference output value of the gyro sensor R1′ is changed to another value, such that the changed reference output value of the gyro sensor R1′ is calculated by the above-mentioned equations. In more detail, the changed reference output value of the gyro sensor R1′ is denoted by 512−(((10×2)−(10×8))/(2+8))=518. Also, the changed reference output value of the other gyro sensor R2 for detecting the elevation angle can be calculated using the same method as the above gyro sensor R1′.

If the changed reference output values of the gyro sensors R1′ and R2 are calculated using the above-mentioned processes, the reference output values of the gyro sensors R1′ and R2 are changed to newly-calculated reference output values such that they are updated to new reference output values at step S280.

When calibrating the reference output values of the gyro sensors R1′ and R2 using the above steps S23˜-S280, the control board continuously detects the intensity of a satellite signal. If the intensity of the satellite signal is higher than a reference intensity, the above steps S230˜S280 are performed. Otherwise, if the intensity of the satellite signal is less than the reference intensity, the reference output values of the gyro sensors R1′ and R2 are changed to original reference output values, a satellite position is re-detected, and then the above steps S230˜S280 are re-performed.

If the system is not terminated at step S290, the above-mentioned process for calibrating the reference output values of the gyro sensors is continuously repeated along with a satellite tracking process.

In accordance with a preferred embodiment of the present invention, the configuration for detecting the azimuth angle using a single gyro sensor R1′, which is mounted to the back surface of the antenna plate 111 and is arranged in perpendicular to a target direction of the antenna 110, can be applied to the one-axis antenna system. FIG. 15 is a rear view illustrating the antenna plate of the one-axis satellite tracking antenna system in accordance with another preferred embodiment of the present invention.

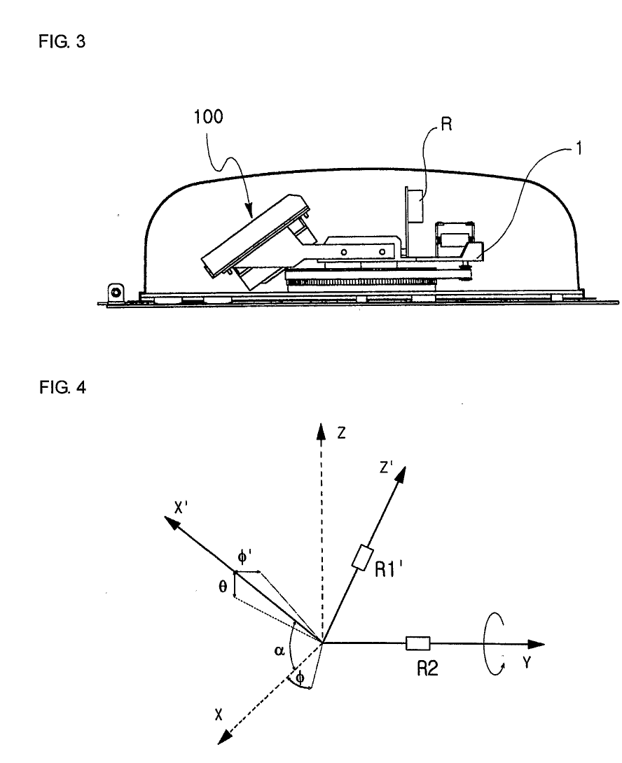

The one-axis satellite tracking antenna system of FIG. 15 mounts a single gyro sensor R1′ for measuring an azimuth angle to a vertical axis of the back surface of the antenna plate 111 such that it can correctly detect the movement of azimuth angle of the moving object using the above processes shown in FIGS. 4 to 14, whereas the conventional one-axis antenna system of FIG. 3, which includes a single gyro sensor arranged in perpendicular to the base plate 1 so as to detect an azimuth angle, cannot correctly measure the azimuth angle according to the horizontal movement of a moving object.

Also, the installation position of the gyro sensor R1′ for detecting the azimuth angle can be properly changed to another position. FIG. 16 is a structural diagram illustrating the one-axis satellite tracking antenna system in accordance with yet another preferred embodiment of the present invention. Referring to FIG. 16, instead of installing the single gyro sensor R′ to the back surface of the antenna plate 111 of FIG. 15, the present invention arranges the gyro sensor R′ perpendicularly to an additional panel on which the elevation angle equal to that of the antenna 110 is formed, such that it can correctly detect the movement of azimuth angle of the moving object.

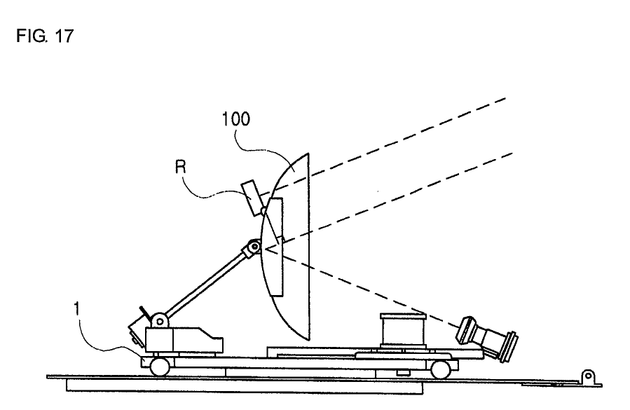

Although the present invention describes the antenna unit 100 comprised of a flat-panel antenna, it should be noted that the antenna unit 100 is not limited to the flat-panel antenna and is applicable to other antennas. In other words, the antenna unit 100 of the present invention is applicable to not only the flat-panel antenna, but also a variety of antennas, for example, a general parabolic antenna and a Cassegrainian antenna, etc. FIG. 17 shows an example in which the satellite tracking antenna system is applied to the parabolic antenna in accordance with the present invention. Referring to FIG. 17, the gyro sensor R is mounted to the parabolic antenna such that it is orthogonal to a satellite target direction of the parabolic antenna. Therefore, the gyro sensor R detects the movement of a moving object, detects a satellite position, and tracks the satellite position.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A satellite tracking antenna system mounted to a moving object to track a satellite position, which includes an antenna unit 100 for receiving a satellite signal; a gyro sensor unit 200 for detecting the movement of a moving object; a control board 300 for receiving intensity information of the satellite signal from the antenna unit 100, receiving moving information of the moving object from the gyro sensor unit 200, and tracking the satellite position according to the received intensity and moving information; and an azimuth angle motor 410 and an elevation angle motor 420 for rotating the antenna unit to be directed to the satellite according to a control signal generated from the control board 300, the system comprising:
the gyro sensor unit 200 is mounted on a Plane perpendicular to a satellite-directed target point of the antenna unit 100, in the gyro sensor unit 200 the gyro sensor R2 for measuring a angular velocity variable in an elevation angle of the moving object is arranged horizontally and the gyro sensor R1′ for measuring an angular velocity variable in an azimuth angle of the moving object is arranged vertically, orthogonal to each other; and,
R2 and R1′ transmit the angular velocity variable in the elevation angle and in the azimuth angle to the control board 300.

2. The system according to claim 1, wherein the first and second gyro sensors R1′ and R2 contained in the gyro sensor unit 200 are arranged to be orthogonal to each other to a back surface of an antenna plate for supporting an antenna 110 contained in the antenna unit 100, in which the first gyro sensor is arranged in a horizontal direction and the second gyro sensor is arranged in a vertical direction.

3. The system according to claim 1, wherein the azimuth angle motor 410 is mounted onto a fixed base plate 1 capable of being horizontally rotated by a vertical axis S1 in an antenna lower cover H detachably covered with a dome-shaped cover C, mounts a bearing 5 for use in the vertical axis S1 onto a top surface of the base plate 1, and transmits power to the vertical axis Si exposed toward a lower part of the base plate 1 via a timing belt 6 connected to a lower drive pulley 2a.

4. The system according to claim 1, wherein the elevation angle motor 420 is mounted to a motor fixing unit 1a, which is bent and formed on one surface of a fixed base plate 1 capable of being horizontally rotated by a vertical axis Si via a bearing 5 in an antenna lower cover H detachably covered with a dome-shaped cover C.

5. The system according to claim 4, wherein:
a semicircular pulley 3 is fixed by first and second fixed plates 7a and 7b to one side of a back surface of an antenna plate 111 for supporting the antenna 110 contained in the antenna unit 100, and a third fixed plate 7c is fixed to the other side of the back surface of the antenna plate 111, such that the first to third fixed 7a, 7b, and 7c plates are rotatably coupled to an extended-bent support unit 1b located on both sides of the base plate 1, and are rotated on the basis of a horizontal axis S2, and
a timing belt 4 fixes its one end to both ends of the semicircular pulley 3, and is connected to a drive pulley 2b of the elevation angle motor 420 via a separation prevention groove 3a formed on a circumference of the semicircular pulley 3, such that the elevation angle of the antenna plate 111 is controlled.

6. The system according to claim 5, wherein the support unit 1b of the base plate 1 includes a limit switch 8 which is turned on by touch action of the antenna plate 111 when the antenna plate 111 is arranged in parallel to the base plate 1 in a vertical rotation process of the antenna plate 111.

7. A one-axis satellite tracking antenna system mounted to a moving object to track a satellite position, which includes an antenna unit for receiving a satellite signal; a gyro sensor for detecting the movement of a moving object; a control board for receiving intensity information of the satellite signal from the antenna unit, receiving moving information of the moving object from the gyro sensor, and tracking the satellite position according to the received intensity and moving information; and an azimuth angle motor for rotating the antenna unit according to a control signal generated from the control board such that an azimuth angle of the antenna unit is directed to the satellite, the system comprising:
the gyro sensor which is mounted vertically on a plane in perpendicular to a satellite-directed target point of the antenna unit, measures an angular velocity variable in the azimuth angle of the moving object, and transmits the measured angular velocity to the control board.

8. A satellite tracking method for use in a satellite tracking antenna system mounted to a moving object to track a satellite position, which includes an antenna unit 100 for receiving a satellite signal; a gyro sensor unit 200 for detecting the movement of a moving object; a control board 300 for receiving intensity information of the satellite signal from the antenna unit 100, receiving moving information of the moving object from the gyro sensor unit 200, and tracking the satellite position according to the received intensity and moving information; and an azimuth angle motor 410 and an elevation angle motor 420 for rotating the antenna unit 100 to be directed to the satellite according to a control signal generated from the control board 300, the method comprising the steps of:
a) measuring reference output values of first and second gyro sensors R1′ and R2 contained in the gyro sensor unit 200, the first and second gyro sensors being mounted to a back surface of an antenna plate 111 perpendicular to a satellite-directed target point of the antenna unit 100 such that they are orthogonal to each other in horizontal and vertical directions;
b) horizontally and vertically rotating the antenna unit 100 using the azimuth angle motor 410 and the elevation angle motor 420, detecting a specific point at which the intensity of the satellite signal received from the antenna unit is higher than a reference value, and detecting an initial position of the satellite on the basis of the detected point;
c) receiving intensity information of the satellite signal from the antenna unit 100, receiving movement information in azimuth and elevation angles of the moving object from the first and second gyro sensors R1′ and R2, and continuously tracking the satellite position detected at step (b) according to the received intensity and movement information; and
d) calculating output values of the first and second gyro sensors R1′ and R2 continuously changed with peripheral environments at step (c) for tracking the satellite position, and calibrating reference output values of the first and second gyro sensors R1′ and R2.

9. The method according to claim 8, wherein the step a) for measuring the reference output values of the first and second gyro sensors R1′ and R2 includes the steps of:
a1) driving the elevation angle motor 420, and allowing the antenna plate 111 to which the first and second gyro sensors R1′ and R2 are mounted to be in parallel to a base plate 1 using the elevation angle motor 420;
a2) measuring the output values of the first and second gyro sensors R1′ and R2 at intervals of a predetermined time on the condition that the first and second gyro sensors R1′ and R2 are arranged in parallel to the base plate 1 such that they are unaffected by the movement of the azimuth angle of the moving object; and
a3) calculating a mean value of the output value of the first gyro sensor R1′ and a mean value of the output value of the second gyro sensor R2, respectively, and acquiring reference output values of the first and second gyro sensors.

10. The method according to claim 8, wherein the step d) for calibrating the reference output values of the first and second gyro sensors R1′ and R2 includes the steps of:
d1) arbitrarily changing reference output values of the first and second gyro sensors R1′ and R2 to others, and controlling the antenna unit 100 to be rotated on the basis of the satellite such that the antenna unit 100 rotates along a square line in a predetermined direction centering around the satellite;
d2) measuring four times in four directions (i.e., right, left, and up and down directions) consumed when the antenna unit rotates along the square line according to the changed reference values of the first and second gyro sensors R1′ and R2, respectively; and
d3) calculating the measured four times consumed when the antenna unit rotates in the four directions and the arbitrarily-changed reference output values of the first and second gyro sensors R1′ and R2, acquiring changed reference output values of the first and second gyro sensors R1′ and R2, and calibrating the reference output values of the first and second sensors R1′ and R2 using the acquired reference output values.
